(19) United States
(12) Patent Application Publication
(10) Pub. No.: US 2011/0313842 A1
(43) Pub. Date: Dec. 22, 2011

(54) SYSTEM AND METHODS THEREOF FOR PROVIDING AN ADVERTISEMENT PLACEMENT RECOMMENDATION BASED ON TRENDS

(75) Inventors: Amit Avner, Herzliya (IL); Omer Dror, Tel Aviv (IL)

(73) Assignee: TAYKEY LTD., Herzliya (IL)

(21) Appl. No.: 13/225,055

(22) Filed: Sep. 2, 2011

Related U.S. Application Data
(63) Continuation-in-part of application No. 13/050,515, filed on Mar. 17, 2011.
Application No. 13/050,515 is a continuation-in-part of application No. 13/214,588, filed on Aug. 22, 2011.
(60) Provisional application No. 61/316,844, filed on Mar. 24, 2010.

(51) Int. Cl. G06Q 30/00

(52) U.S. Cl. 705/14.41; 705/14.49

(57) ABSTRACT

A method for bidding for an advertisement placement of an on-line advertisement. The method comprises identifying at least a trend for at least a first term appearing in at least one data source; extracting at least a second term from at least one on-line advertisement; performing a correlation analysis, responsive of a desired trend of the at least first term, between the at least first term and the at least second term; and placing a bid for placement of the at least one on-line advertisement for any one of the at least first term and the at least second term that demonstrates a predefined correlation.

### CROSS-REFERENCE TO RELATED APPLICATIONS

This application is a continuation-in-part of U.S. patent application Ser. No. 13/050,515, filed on Mar. 17, 2011 which claims the benefit of U.S. provisional application No. 61/316,844 filed on Mar. 24, 2010. This application is also a continuation-in-part of U.S. patent application Ser. No. 13/214,588, filed on Aug. 22, 2011. The contents of each of these applications are incorporated herein by reference.

### TECHNICAL FIELD

The invention generally relates to the generation of term taxonomies based on information available on the Internet, and more specifically to the generation of taxonomies with respect to a plurality of terms, and particularly social terms that are user generated, and respective sentiments and sentiment trends thereto.

### BACKGROUND OF THE INVENTION

There is an abundance of information available on the Internet through content on web pages, social networks, as well as other sources of information, which are accessible via the world-wide web (WWW). Search systems make the access to such information speedy and generally cost effective. However, there are also certain disadvantages, one of which is the fact that even targeted searches to generally available information result in large amounts of ‘hits’ requiring the user to sift through a lot of unwanted information. The search is static by nature and over time, as more and more irrelevant data is available, the more difficult it is to get to meaningful information.

Various users of information are interested in more elaborate analysis of the information available through the Internet as well as the time-value of such information. That is, older information may be less important than newer information and the trends relating to the information may be more interesting than the data relating to the information at any given point in time. Current solutions monitor online behavior, rather than attempting to reach intents. For example, today advertisers attempting to target customers can merely do so based on where they go, what they do, and what they read on the web. For example, a user reading about the difficulties of a car manufacturer might be targeted for an advertisement to purchase that manufacturer's car, which would not necessarily be appropriate. In other words, today's available solutions are unable to distinguish this case from an article where the same company presents a new model of a car. Likewise, the prior art solutions are unable to correlate items appearing in such sources of information to determine any kind of meaningful relationship.

Today, advertising is all about demographics and does not handle true intent. Advertisers are trying to target people based on, for example, their age and music preferences, rather than capturing the target audience's true intent. In search advertising, i.e., when a search is performed for the purpose of delivering an advertisement in conjunction with a search term, for example, when searching for “Shoes”, the age and/or the gender of the user who submits the search query does not necessarily affect the content of the advertisements displayed to the user. Advertisements for shoes are provided merely because searchers have the intent for shoes. However, this intent-based approach is limited in scope and inaccurate in targeting the required audiences. Moreover, due to the short attention span when on-line, trends erupt and disappear within short periods of time and advertisers either miss on adapting to the trend on time or continue advertisements long after the trend is a matter of distant history. Typically, an on-line trend may be for a period that is few tens of minutes to a few tens of hours at the most.

An ability to understand human trends dynamically as they are expressed would be of significant advantage to advertisers, presenters, politicians, chief executive officers (CEOs) and others who may have an interest in deeper understanding of the information and the target audience's true intent. Another advantage to advertisers would be to determine based on such trends biding preferences on advertisement placements. Another advantage to advertisers and campaign managers would be to detect in real-time the appearance of a trend as well as its subsiding thereafter.

Tools addressing such issues are unavailable today and hence it would be advantageous to provide such tools.

### SUMMARY OF THE INVENTION

Certain embodiments disclosed herein include a method for bidding for an advertisement placement of an on-line advertisement. The method comprises identifying at least a trend for at least a first term appearing in at least one data source; extracting at least a second term from at least one on-line advertisement; performing a correlation analysis, responsive of a desired trend of the at least first term, between the at least first term and the at least second term; and placing a bid for placement of the at least one on-line advertisement for any one of the at least first term and the at least second term that demonstrates a predefined correlation.

Certain embodiments disclosed herein also include a system for bidding for an advertisement placement of an on-line advertisement. The system comprises a network interface enabling an access to one or more data sources through a network; a first mining unit for collection of textual content from the one or more data sources and generation of at least a first term; an analysis unit for identifying of a trend for the at least first term; a second mining unit for extracting of at least a second term from an at least one on-line advertisement; an analysis unit for correlating between the at least first term and the at least second term performed responsive of a desired trend of the at least first term; and an output unit for placement of a bid for at least an advertisement placement for any one of the at least first term and the at least second term that demonstrates a predefined correlation.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system for creation of term taxonomies by mining web based user generated content according to an embodiment of the invention.

FIG. 2 is an overview block diagram of the operation of the system.

FIG. 3 is a detailed block diagram of the operation of the system depicted in FIGS. 1 and 2 according to an embodiment of the invention.

FIG. 4 is a flowchart describing a method for creation of term taxonomies by mining web based user generated content according to an embodiment of the invention.

FIG. 5 is a flowchart describing a method for bidding for an advertisement placement based on a trend of a term and correlation between the terms in a trend and in an advertisement.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain embodiments disclosed herein allow for real-time crawling through user generated connect, for example, social networks on the web, analyzing the content, and creating real-time recommendations for an advertising placement or recommendations for placing a bid for an advertising placement based on terms found. The creation of such recommendations enables the user to determine whether to increase or decrease an advertisement bid. A user of the system may be, without limitation, a campaign manager, a presenter, a CEO, a politician running an on-line campaign, and so on.

For instance, and merely as a way of demonstration and not by way of limitation, one can consider the following example. Assuming that an advertiser of a brand name soft drink advertises to people who talk about music. Now consider a reality show that deals with music and where a celebrity judge just fell off the stage. The increase in the trend will be detected in practically real-time by the system, possibly within a few seconds. As the trend relates to music and as it is likely that persons who are related to music will now flock to understand what is going on, the system will cause the purchase of or bidding on advertisement placement in conjunction with the keyword respective of the name of the celebrity judge because it is anticipated that within a short period of time people will search for to see the fall. The advertisement will therefore receive relevant and “trendy” exposure. Such advertisement placement locations may be bought for Google®, Facebook®, Twitter®, etc. potentially even without having to pay premium rates because of the early detection, but certainly guaranteeing exposure as early as possible. Similarly, as the trend fades away, the system will cease placement of advertisements as their effect will be diminishing, whereas their costs may be high because space may be scarce.

The system can generate a purchase of or a bid for an advertisement placement. The advertisement placement may be a function of one or more, or combination thereof of the following criteria, a web site, certain web pages in a web site, a location in a web page, and the duration of time to display the ad in a location. In addition, placement of advertisements may be in an application downloaded to a user device (e.g., APPS) and having connectivity to the Internet. Such an application may include, but is not limited to, an on-line game, a productivity application, a native application, and so on. Without departing from the scope of the invention, advertisements discussed herein include any form of on-line advertisements.

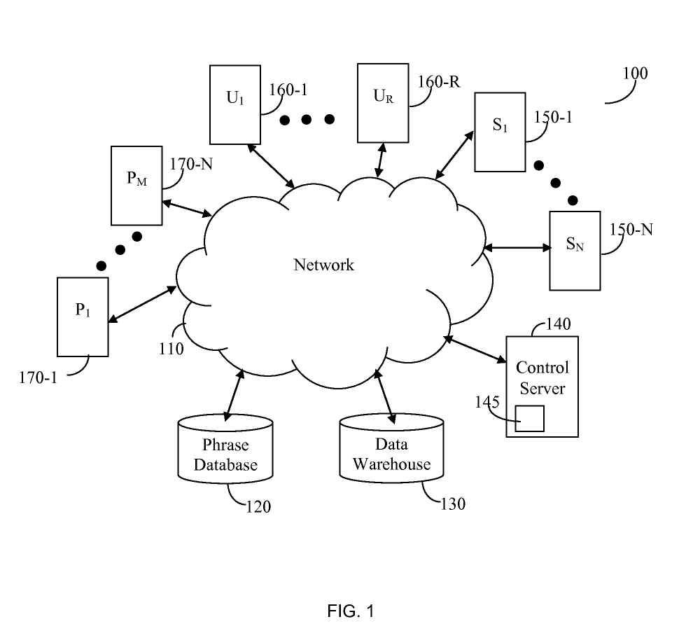

FIG. 1 depicts an exemplary and non-limiting schematic diagram of a system 100 for creation of term taxonomies according to an embodiment of the invention. To a network 110 there are connected various components that comprise the system 100. The network 110 can be a local area network (LAN), a wide area network (WAN), a metro area network (MAN), the world wide web (WWW), the Internet, the likes, and combinations thereof.

A phrase database 120 is connected to the network 110 and contains identified phrases that are either preloaded to the phrase database 120 or, that were detected during operation of the system as such phrases, and as further explained in greater detail herein below. Phrases may contain, but are not limited to, terms of interest, brand names, and the like. A data warehouse 130 is also connected to the network 110, for storing processed information respective of phrases and as further explained in greater detail herein below. The operation of the system 100 is controlled by a control server 140 having executable code stored in a memory 145, such that the control server 140 may perform the tasks discussed in more detail herein below. The memory 145 may be any form of tangible memory.

While the processing may be performed using solely the control server 140, embodiments of the invention may include one or more processing units 170-1 through 170-N which allow for handling of the vast amount of information needed to be processed, without departing from the scope of the invention.

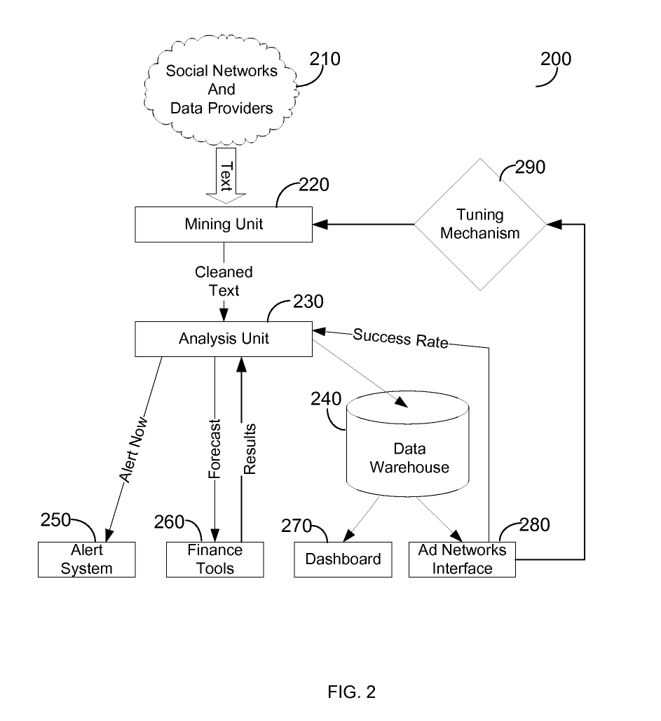

Also connected to the network 110 are one or more sources of information 150-1 through 150-N. These may include, but are not limited to, social networks, e.g., Facebook®, Twitter™, web pages, blogs, and other sources of textual information. Typically, a plurality of users using user nodes 160-1 through 160-R access the information sources 150-1 through 150-N periodically and provide their own comments and information therein. According to the teachings disclosed herein, it is these types and pieces of information that are used by the system 100 for its operation which is described in further detail with respect of FIG. 2 and which are processed by the system 100.

A user node 160-j (j=1, . . . , R) is a computing device operated by a user and includes, but is not limited to, a personal computer, a smart phone, a mobile phone, a tablet computer, or any type of device that enables connectivity to the Internet.

FIG. 2 shows an exemplary and non-limiting overview block diagram 200 of the operation of the system 100. One or more data sources 210, including, but not limited to, social networks and other user provided sources of information 210 are checked and or regularly supplied for text to be provided to a mining unit 220 that performs a mining process. The access to the data sources 210 is through the network 110 by means of a network interface (not shown). In an embodiment of the invention, the mining process can be executed by a mining unit of the system 200.

The task of the mining process is to extract from the text all irrelevant data that cannot be effectively used in the analysis that is performed by the system. Basically, the mining task is to identify sentiment phrases and non-sentiment phrases. In addition to sentiment extraction, the mining process “cleans” the data collected. Sentiment phrases may include, but not by way of limitation, words such as “love”, “hate”, “great”, “disaster”, “beautiful”, “ugly” and the like, but also “not good”, “great time”, “awfully good”, and more. Cleaning of data may include phrases common in social networks such as, but of course not limited to, conversion of “GRREEEAT!” into “great” and so on. In addition, cleaning may include removing conjunctions and words that appear with extremely high frequency or are otherwise unknown or irrelevant. While single words have been shown here, multiple words grouped as a phrase may also be treated as a sentiment phrase, such as but not by way of limitation “great experience”, “major issues”, “looks great” and more. These words describe a sentiment typically applied to a non-sentiment phrase.

The text coming in from the one or more data source(s) 210 is mined for such phrases, for example, by using a reference for phrases stored in a database, such as the phrase database 120. The mining process includes understanding that a complex phrase such as “I hate I Love Lucy” actually contains a sentiment phrase “love” and a non-sentiment phrase “I Love Lucy”, where the word “love” in the non-sentiment phrase is not to be analyzed as a standalone phrase. Furthermore, the sentence “I saw the movie I love Lucy” does not comprise any sentiment phrase, and therefore would not cause the mining unit 220 using the mining process to associate a sentiment phrase to the non-sentiment phrase. The phrases database 120, in one embodiment, is a preloaded database and updated periodically. However, it is also possible to automatically update the phrase database 120 upon detection of a phrase as being either one of a sentiment phrase or a non-sentiment phrase. Furthermore, a sentiment phrase within a non-sentiment phrase is ignored for this purpose as being a sentiment phrase and is only treated as part of the non-sentiment phrase. It should therefore be understood that a taxonomy is created by association of a non-sentiment phrase with a sentiment phrase. Hence, for example, in the context of the phrase “I hate I Love Lucy” the sentiment phrase is “hate”, the non-sentiment phrase is “I Love Lucy” and the phrases are associated together in accordance with the principles of the invention to create a taxonomy.

According to another embodiment of the invention, a comparative numerical value is associated with each sentiment. For example, the word “love” may have a score of “10”, the word “indifferent” the score of “0” and “hate” the score of “−10”. Hence, positive sentiments would result in a positive score while negative sentiments would result in a negative score. Such score associations may be performed initially manually by a user of the system, but over time the system 100, based on a feedback provided by, e.g., a tuning mechanism 290, can position the sentiment phrases relative to each other to determine an ever changing score value to every sentiment phrase. This is of high importance as language references change over time and references which may be highly positive can become negative or vice versa, or decline or incline as the case may be. This can be achieved by aggregation of sentiments with respect to a specific non-sentiment phrase resulting in a taxonomy that reflects the overall sentiment to the non-sentiment phrase.

In an embodiment of the invention, a weighted sentiment score corresponding to a plurality of sentiment phrases collected for a respective non-sentiment phrase is generated. That is, within a specific context, the plurality of sentiments associated with a non-sentiment phrase are collected, and then an aggregated score is generated. The aggregated score may be further weighted to reflect the weight of each of the individual scores with respect to other scores.

The cleaned text that contains the phrases is now processed using an analysis process which in an embodiment of the invention is performed by an analysis unit 230 of the system 200. The analysis may provide based on the type of process information needed, the likes of alerts and financial information. An alert may be sounded by an alert system 250 if it is determined that a certain non-sentiment phrase, for example, a certain brand name, is increasingly associated with negative sentiment phrases. This may be of high importance as the manufacturer associated with the brand name would presumably wish to act upon such negative information as soon as possible in real-time. Likewise, a positive sentiment association may be of interest for either supporting that sentiment by certain advertising campaigns to further strengthen the brand name, or by otherwise providing certain incentives to consumers of products of the brand name. Those of ordinary skill in the art would readily realize the opportunities the system 100 and embodiment 200 provide.

In an embodiment of the invention, the analysis unit performs the analysis process that uses the associations of non-sentiment and sentiment phrases to periodically generate at least a statistical analysis on the associations of phrases. By performing the statistical analysis the sentiment of different terms over time can be determined. For example, the trend of a sentiment phrase with respect of a non-sentiment phrase or the trend of a taxonomy term (created by association of a sentiment phrase to its respective non-sentiment phrase). In addition, the statistical analysis can determine the frequency of the same term appearing in two different web-based data sources. The techniques for determining the trends of terms are discussed in the co-pending U.S. patent application Ser. No. 13/214,588, assigned to the common assignee.

Returning to FIG. 2, the analyzed data is stored in a data warehouse 240, shown also as data warehouse 130 in FIG. 1. Through a dashboard utility 270 it is possible to provide queries to the data warehouse 240. An advertisement network interface 280 further enables advertising related management, for example, providing advertisements relative to specific phrases used. In addition, the information is tuned by a tuning mechanism 290 thereby allowing for feedback to enable better mining of the data by the mining unit 220. In the case of an advertisement a success rate, for example conversion rates, is also provided to the analysis process for better analysis of the cleaned text by creating real time taxonomies.

An analysis may further include grouping and classification of terms in real-time, as they are collected by the system. Furthermore, current trends can be analyzed and information thereof provided, including, without limitation, an inclining trend and a declining trend with respect to the sentiment phrase associated with a non-sentiment phrase. Moreover, using the analysis process performed by the analysis 230 it is possible to detect hidden connections, i.e., an association between non-sentiment phrases that have a correlation. For example, if a web site of a talk show refers more positively or more frequently to a brand name product, the system 100 through its phrase analysis is able to find the correlation between the non-sentiment phrases and then compare the sentiment phrases thereof. That way, if the talk show web site tends to favor and recommend the brand name product it would make more sense to spend, for example, advertisement money there, than if the sentiment phrase would be a negative one.

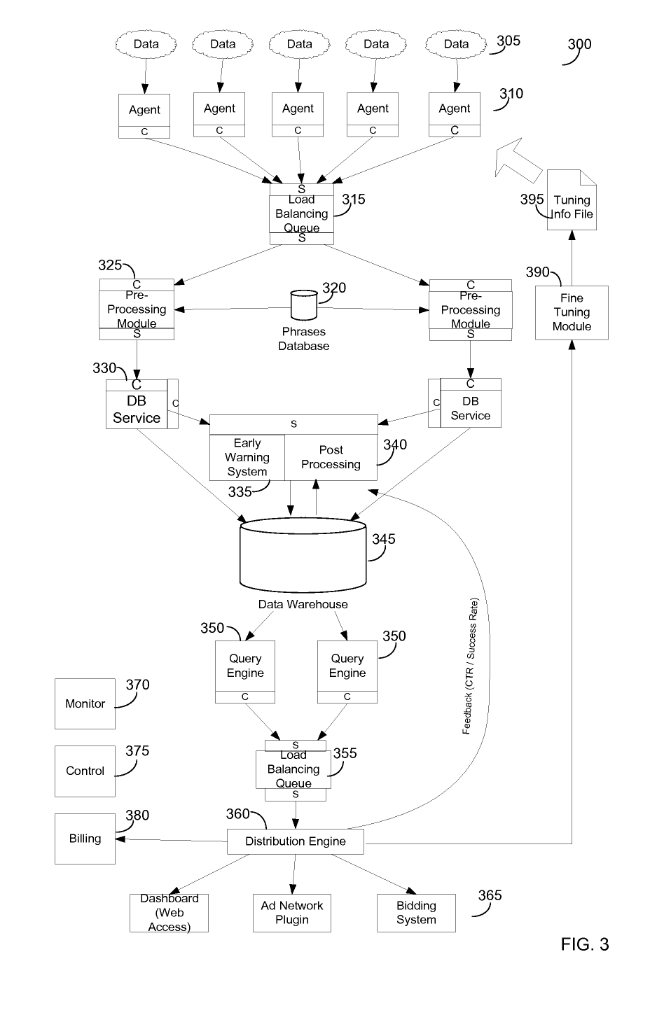

FIG. 3 shows an exemplary and non-limiting detailed block diagram of the operation of a system 300 according to the principles of the invention. Data sources 305, including the web sites and web services like of Facebook® and Twitter™, but not limited thereto, are probed periodically by agents 310 of the system 300. The agents 310, in one embodiment, are operative under the control of the control server 140 or any one of the processing units 170, when applicable. A load balancing queue 315, operative for example on the control server 140, balances the loads of the agents 310 on the execution units such that their operation does not overload any one such unit. In the exemplary and non-limiting implementation, two processing paths are shown, however, more may be used as may be necessary.

In one embodiment, the loading of an agent 310 is also a function of the periodic checking of the respective data source 305. Each processing unit, for example, processing units 170, performs a preprocessing using the preprocessing module 325. The preprocessing, which is the mining of phrases as explained hereinabove, is performed respective of a phrase database 320 to which such processing units 170 are coupled to by means of the network 110. A database service utility 330, executing on each processing node 170, stores the phrases in the data warehouse 345, shown in FIG. 1 as the data warehouse 130. An early warning system 335, implemented on one of the processing units 170 or on the control server 140, is communicatively connected with the database service utility 330, and configured to generate early warning based on specific analysis. For example, an increase of references to a brand name product above a threshold value may result in an alarm. In one embodiment, this happens only when the source of such an increase is a specific source of interest. This is done because some sources 305 are more meaningful for certain non-sentiment phrases than others, and furthermore, some sentiment phrases are more critical when appearing in one source 305 versus another.

The second portion of the system 300 depicted in FIG. 3, concerns the ability to query the data warehouse 345 by one or more query engines 350, using a load balancing queue 355 as may be applicable. The queries may be received from a plurality of sources 365 including, but not limited to, a dashboard for web access, an advertisement network plugin, and a bidding system. The sources 365 are connected to a distribution engine that receives the queries and submits them to the load balancing queue 355 as well as distributing the answers received thereto. The distribution engine further provides information to a fine tuning module, executing for example on the control server 140, and then to an exemplary and non-limiting tuning information file 395. Other subsystems such as a monitor 370 for monitoring the operation of the system 300, a control 375, and a billing system 380 may all be used in conjunction with the operation of the system 300.

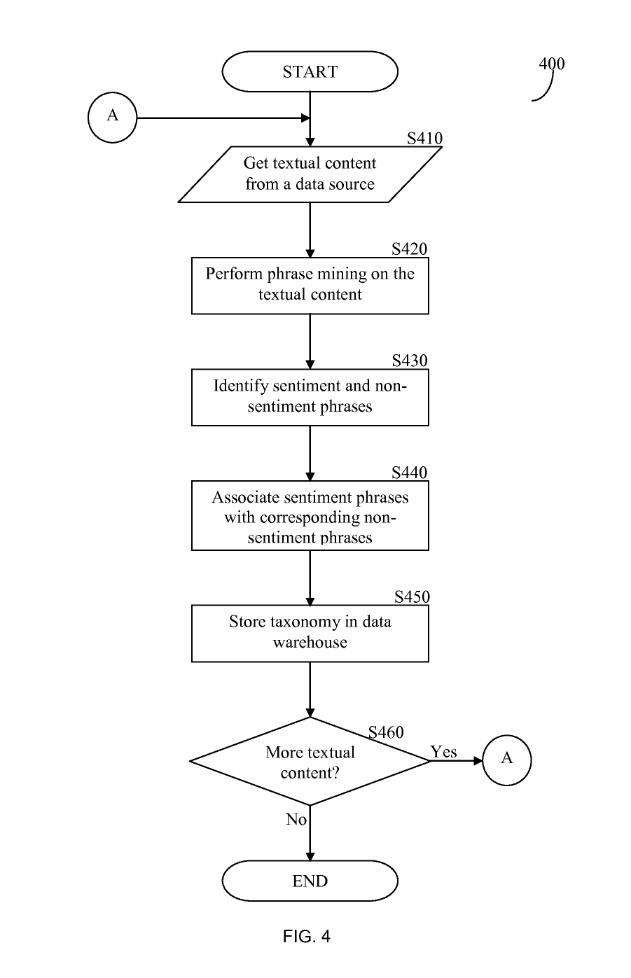

FIG. 4 shows an exemplary and non-limiting flowchart 400 of a method for creation of term taxonomies. In S410, the system, for example and without limitations, anyone of the systems 100, 200 and 300 described hereinabove, receives textual content from one or more information sources. As shown above, this can be performed by using the agents 310. In S420, phrase mining is performed. The phrase mining includes at least the detection of phrases in the received content and in S430 identification and separation of sentiment and non-sentiment phrases. In S440, sentiment phrases are associated with non-sentiment phrases as may be applicable. In S450, the taxonomies are created by association of sentiment phrases to their respective non-sentiment phrases, including by way of, but not limited to, aggregation of sentiment phrases with respect to a non-sentiment phrase. The created taxonomies then are stored, for example, in the data warehouse 130. This enables the use of the data in the data warehouse by queries as also discussed in more detail hereinabove. In S460, it is checked whether additional text content is to be gathered, and if so execution continues with S410; otherwise, execution terminates.

It should be noted that an analysis takes place to determine the likes of current trends respective of the non-sentiment phrases based on their sentiment phrases, prediction of future trends, identification of hidden connections and the like.

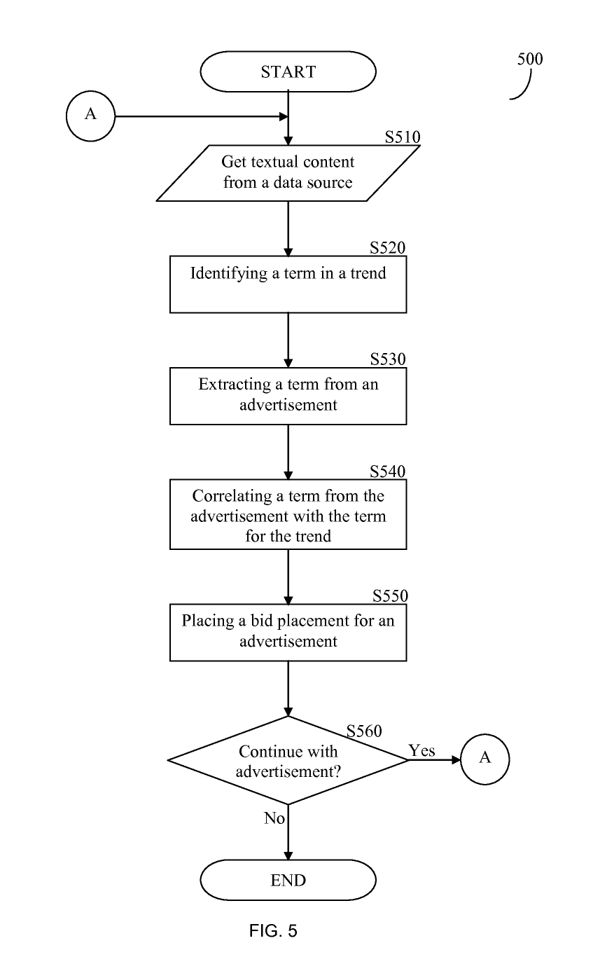

FIG. 5 shows an exemplary and non-limiting flowchart 500 describing the principle operation of the system for bidding for advertisement placement based on trends of a term and correlation to terms corresponding to the advertisement. In S510 the system, for example and without limitations, any one of the systems 100, 200 and 300 described hereinabove, receives textual content from one or more information sources. These sources may include, but are not limited to, social networks (e.g., Facebook, Twitter, Google+, etc.) blogs, web pages, news feeds, and the like.

In S520, the system identifies a trend for the term. As described in detail above and in co-pending U.S. patent application Ser. No. 13/214,588, this step may include performing at least a statistical analysis respective of the term and generating a trend report based at least on the at least statistical analysis. In one embodiment of the invention, the term is a term taxonomy generated by associating between one or more non-sentiment phrases and one or more sentiment phrases detected in the received textual content.

In S530, the system extracts a term from the advertisement. Such a term may be a metadata of the advertisement, for example, an advertisement for a shoe may include terms such as the brand name, catalog number of the shoe, and so on, as well as other metadata that is considered to be relevant for the advertisement. The metadata is extracted by referring to the metadata for the purpose of the analysis. In S540, the system correlates between the term extracted from the advertisement (in S530) and a term identified in the trend (in S520). It should be understood that the term having a trend and the term from the advertisement need not be identical necessarily, but rather showing a high correlation which is above a predetermined threshold, or conversely, a distinct negative correlation if such is preferred. It should be further noted that it may be reasonable to place an advertisement if the correlation is above a certain positive threshold and below a certain negative threshold where the positive threshold and the negative threshold need not necessarily be identical in absolute values. This would allow, for example, bidding for an advertisement placement to an audience who is not indifferent even though they may either approve or disapprove strongly in either way.

In S550, the system places a bid for an advertisement placement based on the correlation as discussed in more detail hereinabove. In S560, it is checked whether to continue with advertisement placement, and if so, execution returns to S510; otherwise, execution terminates.

In an embodiment of the method described herein, the method continuously tracks the advertisement placement so as to determine if its performance is per the bidding expectation. Such performance may be the number of clicks it receives, the number of conversions to sale, and so on, and referred to herein below as past results. Then, with respect of its performance, the method may provide the user with a recommendation whether to increase or decrease the advertisement bid based on past results and a profile prediction. The profile prediction attempts to identify profile characteristics for an advertisement based on a collection of past results. That is, determining based on the past results who are the more likely targets to favorably respond to the presence of the advertisement. Based thereon future behavior can be predicted based on similar profiles. Furthermore the method keeps track of the trend, for example by storage in memory, and generates a notification to the user when a trend changes or when a trend crosses a predetermined threshold.

In one embodiment, from a system's perspective, an analysis unit continuously tracks the advertisement to determine if its performance is per the bidding expectation, and as explained in greater detail hereinabove. The analysis unit further provides the user with a recommendation whether to increase or decrease the advertisement expenditure. The analysis unit further provides the user with a notification when upon detection a trend changes. The analysis unit may further provide the user with a notification when the trend crosses a predetermined threshold.

In an embodiment of the method described herein, an analysis takes place to determine the likes of current trends respective of the non-sentiment phrases based on their sentiment phrases, prediction of future trends, identification of hidden connections and the like.

The various embodiments of the invention may be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for bidding for an advertisement placement of an on-line advertisement, comprising:
identifying at least a trend for at least a first term appearing in at least one data source;
extracting at least a second term from at least one on-line advertisement;
performing a correlation analysis, responsive of a desired trend of the at least first term, between the at least first term and the at least second term; and
placing a bid for placement of the at least one on-line advertisement for any one of the at least first term and the at least second term that demonstrates a predefined correlation.

2. The method of claim 1, wherein the at least one or more data sources includes at least one of: a social network, a blog, a web page, a news feed.

3. The method of claim 1, further comprising:
tracking continuously the at least one-line advertisement to determine if its performance is per at least a bidding expectation.

4. The method of claim 3, wherein the performance of the at least on-line advertisement being tracked includes at least one of: a number of clicks and a number of conversions to sale from the advertisement.

5. The method of claim 3, further comprising:
providing a recommendation whether to increase or decrease the at least an advertisement bid based on at least one of: past results, and a profile prediction.

6. The method of claim 4, wherein the past results include tracked performance collected for the at least one on-line advertisement and other similar on-line advertisements, wherein the profile prediction identifies profile characteristics for the at least one on-line advertisement to predict future behavior based on similar profiles.

7. The method of claim 1, wherein identifying the trend for at least a first term comprises:
performing at least a statistical analysis respective of the at least one term.

8. The method of claim 7, wherein the at least one term is at least a term taxonomy generated by associating between at least one non-sentiment phrase and at least one sentiment phrase appearing in the at least one data source.

9. The method of claim 7, further comprising:
generating a notification when the trend changes.

10. The method of claim 9, further comprising:
generating the notification when the trend crosses a predetermined threshold.

11. The method of claim 1, wherein the predefined correlation is at least one of: a minimum threshold of a positive correlation and a maximum threshold for a negative correlation.

12. A computer software product containing a plurality of instructions embedded in a non-transitory computer readable medium that when executed by a computing device causing to execute the method of claim 1.

13. A system for bidding for an advertisement placement of an on-line advertisement, comprising:
a network interface enabling an access to one or more data sources through a network;
a first mining unit for collection of textual content from the one or more data sources and generation of at least a first term;
an analysis unit for identifying a trend for the at least first term;
a second mining unit for extracting at least a second term from an at least one on-line advertisement;
an analysis unit for correlating between the at least first term and the at least second term performed responsive of a desired trend of the at least first term; and
an output unit for placement of a bid for at least an advertisement placement for any one of the at least first term and the at least second term that demonstrates a predefined correlation.

14. The system of claim 13, wherein each of the one or more data sources is at least one of: a social network, a blog, a web page, and a news feed.

15. The system of claim 13, wherein the analysis unit continuously tracks the at least one on-line advertisement to determine if its performance is per at least a bidding expectation.

16. The system of claim 13, wherein the analysis unit further provides a recommendation to increase or decrease advertisement expenditure.

17. The system of claim 13, wherein the analysis unit further provides a notification when the trend changes from expectation.

18. The system of claim 17, wherein the analysis unit further provides a notification when the trend crosses a predetermined threshold.

19. The system of claim 13, wherein the first mining unit and the second mining units are implemented into a single mining unit.

20. The system of claim 13, further comprising:
a storage unit for storing at least one of: the at least first term, the at least second term, the correlation between the at least first term and the at least second term, the trend of the at least first term, and the bid for the advertisement placement.

21. The system of claim 13, wherein the predefined correlation is at least one of: a minimum threshold of a positive correlation and a maximum threshold for a negative correlation.
